(19) United States
(12) Patent Application Publication
(10) Pub. No.: US 2024/0275674 A1
(43) Pub. Date: Aug. 15, 2024

(54) Continuous Architecture As A Service

(71) Applicant: Google LLC, Mountain View, CA (US)

(72) Inventors: Sekou Page, Santa Monica, CA (US); Long Cheng, Bellevue, WA (US); Victor Dantas Mehmeri, Stockholm (SE)

(21) Appl. No.: 18/437,411

(22) Filed: Feb. 9, 2024

Related U.S. Application Data
(60) Provisional application No. 63/485,039, filed on Feb. 15, 2023.

(51) Int. Cl. H04L 41/084; H04L 67/10

(52) U.S. Cl. CPC H04L 41/084; H04L 67/10

(57) ABSTRACT

Aspects of the disclosure are directed to using a set of rules to generate a framework that can allow a user of a cloud-based platform to define their objectives for altering an existing deployment or generating a new deployment of services of the user for the cloud-based platform. The rules can include elements to correlate which rules should be considered collectively as a group, which rules have dependencies on one another, and/or other external factors. The correlated rules can be further curated and filtered based on an ordering of the objectives. A resulting set of rules can represent a specific architecture aligned with the objectives of the user.

### CROSS-REFERENCE TO RELATED APPLICATIONS

The present application claims the benefit of the filing date of U.S. Provisional Patent Application No. 63/485,039, filed Feb. 15, 2023, the disclosure of which is hereby incorporated by reference.

### BACKGROUND

Some users of cloud-based platforms aim to construct and deploy their own services on the cloud-based platforms. Typically, recommendations for these users can be made available, such as reference architectures and documentations for the users to review. However, consuming the required information to properly implement these recommendations can be a daunting task, given the breadth and depth of information required to construct and deploy services on cloud-based platforms. Further, architecture and deployment recommendations can change as new capabilities or services are introduced. Therefore, challenges in adopting recommended architecture practices can extend beyond initial deployment and into the need for ongoing alignment. However, providing an architecture and deployment recommendation is static and only represents a best effort to capture guidance that may work generically for most users without taking into account specific priorities of any one user.

### BRIEF SUMMARY

Aspects of the disclosure are directed to generating a framework based on a set of rules that can allow a user of a cloud-based platform to define objectives for determining the alignment of an existing deployment with the objectives or for new deployments of services of the user for the cloud-based platform. A machine learning model, such as a generative model, can generate the set of rules for the cloud-based platform. Each rule can be generated as a binary, granular condition.

In addition to generating the rules, the machine learning model can also process the rules. Rules can be associated with one another via conditions and/or tags. Rules can also include other elements, such as standards. These elements, e.g., conditions, tags, standards, can be used to correlate which rules should be considered collectively as a group, which rules have dependencies on one another, and/or other external factors. The correlated rules can then be further curated and filtered based on an ordering of the objectives. For example, if two rules conflict, then one rule can be prioritized over the other. Any other conditions and/or standards provided by a user can be taken into account to further refine the correlated rules.

A resulting set of rules can represent a specific architecture aligned with the objectives of the user. The user can then reject specific rules or create additional rules with a clear understanding of how that would impact the architecture. Rules can act as a baseline for specific services and applications of the cloud-based platform based on pre-defined knowledge. The rules can also be dynamic and continually updated with the latest guidance from users as well as operators of the cloud-based platform.

An aspect of the disclosure is directed to a method for continuous architecture as a service including: receiving, by one or more processors, data associated with one or more architectural objectives for a cloud service; generating, by the one or more processors, a plurality of rules for the cloud service based on the data associated with the one or more architectural objectives; grouping, by the one or more processors, the plurality of rules to form one or more modules for the cloud service based on one or more conditions of the architectural objectives; configuring, by the one or more processors, the plurality of rules in the one or more modules based on the one or more conditions; grouping, by the one or more processors, the one or more modules to form a template architecture for the cloud service based on tagging of rules within the one or more modules; and outputting, by the one or more processors, the template architecture for the cloud service.

In an example, the data associated with the one or more architectural objectives further includes data associated with one or more design principles. In another example, the data associated with the one or more architectural objectives further includes data associated with one or more system requirements or standards.

In yet another example, the method further includes determining, by the one or more processors, the plurality of rules in the template architecture aligns with the cloud service. In yet another example, the method further includes: tagging, by the one or more processors, the template architecture with a unique identifier; and deploying, by the one or more processors, the template architecture in response to determining the template architecture aligns with the cloud service. In yet another example, the method further includes determining, by the one or more processors, at least one of the plurality of rules in the template architecture does not align with the cloud service. In yet another example, the method further includes: deviating, by the one or more processors, from the template architecture to generate a deviated template architecture that alters at least one of the plurality of rules in response to determining the template architecture does not align with the cloud service; tagging, by the one or more processors, the deviated template architecture with a unique identifier; and deploying, by the one or more processors, the deviated template architecture. In yet another example, the method further includes generating, by the one or more processors, one or more reasons for deviating from the template architecture.

In yet another example, at least one of the generation of the plurality of rules, grouping of the plurality of rules, configuring of the plurality of rules, or grouping of the one or more modules is performed by one or more machine learning models. In yet another example, the method further includes: converting, by the one or more processors, the plurality of rules into code snippets; and storing, by the one or more processors, the code snippets as structured data.

In yet another example, each rule of the plurality of rules includes a binary statement; and configuring each rule further includes enabling or disabling each rule.

Another aspect of the disclosure provides for a system including: one or more processors; and one or more storage devices coupled to the one or more processors and storing instructions that, when executed by the one or more processors, cause the one or more processors to perform operations for a continuous architecture as a service, the operations including: receiving data associated with one or more architectural objectives for a cloud service; generating a plurality of rules for the cloud service based on the data associated with the one or more architectural objectives; grouping the plurality of rules to form one or more modules for the cloud service based on one or more conditions of the architectural objectives; configuring the plurality of rules in the one or more modules based on the one or more conditions; grouping the one or more modules to form a template architecture for the cloud service based on tagging of rules within the one or more modules; and outputting the template architecture for the cloud service.

In an example, the operations further include determining the plurality of rules in the template architecture aligns with the cloud service. In another example, the operations further include: tagging the template architecture with a unique identifier; and deploying the template architecture in response to determining the template architecture aligns with the cloud service. In yet another example, the operations further include determining at least one of the plurality of rules in the template architecture does not align with the cloud service. In yet another example, the operations further include: deviating from the template architecture to generate a deviated template architecture that alters at least one of the plurality of rules in response to determining the template architecture does not align with the cloud service; tagging the deviated template architecture with a unique identifier; and deploying the deviated template architecture. In yet another example, the operations further include generating one or more reasons for deviating from the template architecture.

In yet another example, at least one of the generation of the plurality of rules, grouping of the plurality of rules, configuring of the plurality of rules, or grouping of the one or more modules is performed by one or more machine learning models. In yet another example, the operations further include: converting the plurality of rules into code snippets; and storing the code snippets as structured data.

Yet another aspect of the disclosure provides for a non-transitory computer readable medium for storing instructions that, when executed by one or more processors, cause the one or more processors to perform operations for a continuous architecture as a service, the operations including: receiving data associated with one or more architectural objectives for a cloud service; generating a plurality of rules for the cloud service based on the data associated with the one or more architectural objectives; grouping the plurality of rules to form one or more modules for the cloud service based on one or more conditions of the architectural objectives; configuring the plurality of rules in the one or more modules based on the one or more conditions; grouping the one or more modules to form a template architecture for the cloud service based on tagging of rules within the one or more modules; and outputting the template architecture for the cloud service.

### BRIEF DESCRIPTION OF THE DRAWINGS

FIG. 1 depicts a block diagram of an example architecture as a service system for a cloud-based platform according to aspects of the disclosure.

FIG. 2 depicts an example module corresponding to a set of rules according to aspects of the disclosure.

FIG. 3 depicts a flow diagram of an example process for generating templates for an architecture as a service framework according to aspects of the disclosure.

FIG. 4 depicts a block diagram of an example machine learning based architecture as a service system according to aspects of the disclosure.

FIG. 5 depicts a block diagram of an example environment for implementing an architecture as a service system according to aspects of the disclosure.

FIG. 6 depicts a block diagram of one or more machine learning model architectures according to aspects of the disclosure.

### DETAILED DESCRIPTION

Generally disclosed herein are implementations for an objective-based architecture as a service framework for a cloud-based platform. Rather than including a manual, binary assessment, e.g., either a user workload comports or does not comport, the framework includes an automated, principle-based assessment, where a user workload can be programmatically assessed to be consistent with certain principles associated with a given tier of the architecture. The framework can include one or more machine learning models, such as large generative models, to generate rules for the architecture and process the generated rules to ensure the rules are aligned with the objectives of the architecture.

The framework can accommodate users of the cloud-based platform, who can accommodate some aspects of a given best practice but cannot adopt others based on cost, time, organizational constraints, or other inhibitors. The framework allows for greater flexibility and can maximize best practice adoption by removing binary “all-or-nothing” approaches of existing frameworks. The framework enables a flexible and full customizable architecture as a service model for users to utilize cloud platform architecture recommendations. The framework can allow a user to choose to align to a particular solution or use case in addition to measure compliance with a standard. The framework also allows flexibility for the user to decline specific rules to support custom architecture requirements while continuing to receive later rule sets to maintain alignment with later framework recommendations.

Most existing solutions relate to configuration frameworks rather than architecture frameworks. Configuration frameworks can check for a specific setting and can report if that setting is true or false. By contrast, architecture frameworks require an understanding of objectives, which can include elements such as conditions, dependencies, and/or relevant standards. For example, a certain collection of conditions can result in the cloud computing environment being deemed as meeting goals in resiliency, performance, security, etc. An architecture that prioritizes performance over resilience can be designed differently than an architecture that prioritizes resilience over performance. Configuration frameworks have little to no sense of the impact on this objective and do not have dependencies both between and within the services or parameters checked to determine or identify an objective. Architecture frameworks can further be dynamic to represent dynamic objectives, where goals for the framework can change over time.

Another distinction from configuration frameworks compared to architecture frameworks is handling of relative importance or weight of each element. If there are 100 configurations for resilience, it is likely some configurations will be more important than others. For example, a cache setting on a load balancer can impact uptime of deployment by making failover take longer. However, the presence of a load balancer can be more significant as a design element to validate. The weight only becomes relevant when the objective of achieving resilience is included. Configuration frameworks would not distinguish having a load balancer from having a specific font set as default. In a configuration framework, the condition is whether or not the configuration was made rather than if it was important to make or not. As a result, architecture frameworks that evaluate an impact of a configuration or design element being present can allow for better reporting of resulting levels of alignment.

Some challenges that existing architecture frameworks face is that they are relatively static, inflexible, do not support automation, lack integration, and are often skill dependent. By contrast, implementations for the architecture framework as generally disclosed herein can leverage a dynamic, rules-based architecture. A set of binary rules governed by and associated with specific design principles can be utilized to provide a template or blueprint for a specific architecture pattern or to review a deployed architecture for alignment. The rules can be generated to represent specific guidance for a specific configuration on a cloud service to align with recommended templates or blueprints.

The framework can provide a prescriptive standard for an architecture to allow a user to align with that architecture by accepting or rejecting specific rules, standards, or design principles. Rejection of a design element, e.g., principle, rule, standard, does not bar the user from using the architecture framework, but rather that there is no expectation of alignment with the rejected element. Instead, users can be provided a score indicating their level of alignment as well as impact based on design principles and documented reason for the deviation. The framework allows the flexibility of both leveraging the recommended architecture while at the same time enabling users to deviate where necessary to align with internal standards and practices. Further, these areas of non-alignment can further be highlighted as opportunities for additional improvement. The alignment can correspond to a reference to inform users of their alignment with standards and provides users with the ability to assess and quantify risk via impacted design principles.

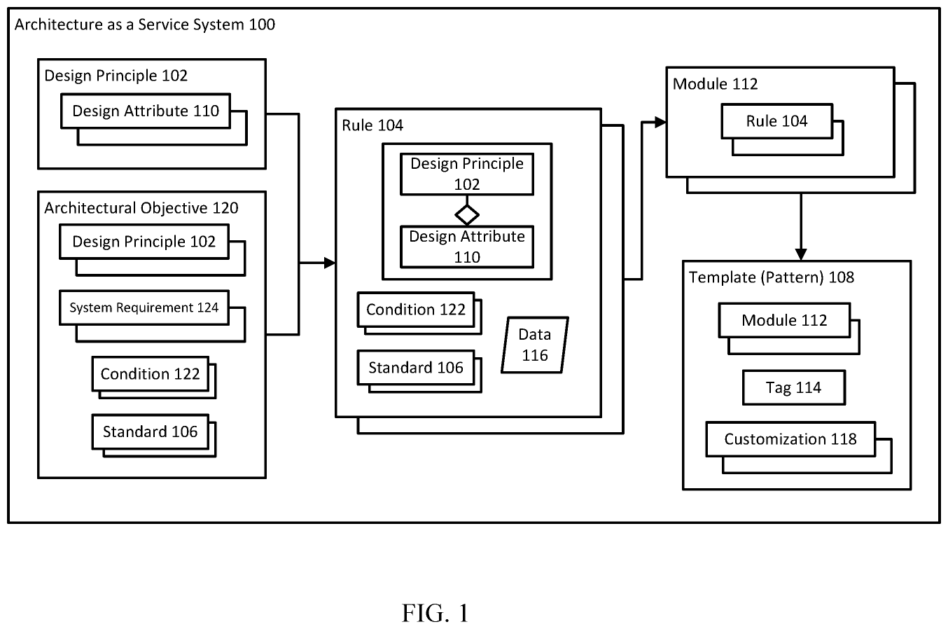

FIG. 1 depicts a block diagram of an example architecture as a service system 100 for a cloud-based platform. The cloud-based platform can provide for services that allow for provisioning or maintaining compute resources and/or applications, such as data centers, cloud environments, and/or container frameworks. For example, the cloud-based platform can be used as a service that provide software applications, such as accounting, word processing, inventory tracking, etc. applications. As another example, the infrastructure of the platforms can be partitioned in the form of virtual machines or containers on which software applications are run. The architecture as a service system 100 can be implemented as one or more computer programs, specially configured electronic circuitry, or any combination of the preceding. The architecture as a service system 100 can be configured to generate a deployment of services or align an existing deployment of services with an objective of a user of the cloud-based platform.

The architecture as a service system 100 includes design principles 102, rules 104, standards 106, and templates 108. The design principles 102 can correspond to purposes of a rule 104, such as performance, and can define standards 106 to which to hold the architecture. The design principles 102 can contain one or more design attributes 110 in a one-to-many relationship. The design attributes 110 can correspond to a granular view of a design principle 102, such as performance should be greater than scalability. The design principles 102 and/or design attributes 110 can correspond to properties of the rules 104. Each rule 104 can have one or more associated design principles 102 and/or design attributes 110 on which it is based. For example, each rule 104 can have one associated design principle 102 and/or design attribute 10 on which it is based. Rules 104 can also include data 116 associated with a desired configuration state of a service.

Rules 104 can be defined at modules 112 of the system 100 and can represent an architectural objective 120. The architectural objective 120 can include the design principles 102 and standards 106 as well as conditions 122 and/or system requirements 124. Modules 112 can correspond to a collection of rules for a specific service. Rules 104 can correspond to a collection of conditions 122 describing a desired alignment of a user of the cloud-based platform. Standards 106 can correspond to properties of rules 104 that identify alignment with an externally defined requirement, such as a government statute or technical requirement. Each rule 104 can be associated with one or more standards 106 in a one-to-many relationship. Standards 106 can act as filters to enable confirmation of alignments with a particular standard 106 in a given architecture.

The templates 108 can correspond to the collection of rules 104 that align with a given, predefined deployment of an architecture. Each service can have a baseline service level template 108, but a template 108 can also be created for a service that is a combination of multiple rule sets from different services. The templates 108 can include tags 114, which can correspond to grouping rules for particular solutions. Tags 114 can be configured to allow mapping of a given template 108 to a subset of modules 112. The templates 108 can also include customization 118 to allow a user of the cloud-based platform to accept or reject specific rules 104, modules 112, tags 114, and/or standards 106. Templates 108 can alternatively or additionally be referred to as patterns 108. Patterns 108 can describe a desired configuration inclusive of the architectural objective 120.

Architectural objectives 120 can capture a purpose of the design for the architecture based on one or more goals for the system. These goals can be based on the design principles 102, such as resilience or performance. These goals can also include system requirements 124, such as supporting 10,000 users or processing 1 million transactions per second. Another example can include achieving a specific service level agreement in resilience. The system requirement 124 can be captured as a condition so that multiple similar rules 104 can be distinguished between and a decision made by the system 100 in processing the rules 104 to know which are appropriate.

The architectural objectives 120 can further include standards 106, such as the system being compliant with a government statute or meeting a technical criterion requiring the use of a certain disk type.

The architectural objectives 120 may also include conditions 122 to capture any specific requirements or cases involving tradeoffs. For example, with performance, a rule may be written such that with one configuration a certain amount of input/output operations per second (IOPS) is supported but with another configuration, a different amount is supported. Rules 104 can be generated such that for each of these thresholds, a condition 122 on IOPS performance is specified. For example, <1000 IOPS can be required for one rule while between 1000 and 5000 IOPS can be required for the next rule with different data 116 for the rule.

The architectural objective 120 can collectively include a plurality of these elements, e.g., design principles 102, system requirements 124, conditions 122, and standards 106, and setting these together can generate sets of rules 104 which each express an aspect of the architectural objective 120 in a granular, measurable, and binary fashion, such as being anchored by a single design principle 102 or design attribute 110.

The design principles 102 can correspond to conceptual goals to achieve. The design principles 102 can consider a number of factors to ensure services can meet requirements of a user. Those requirements can include functional, technical, and/or operational requirements that align with objectives of the user. The design principles 102 can also consider principles associated with designing a cloud environment. Each design principle 102 can include one or more design attributes 110, which further expand and explore the detail of how to align with given principles and support measurement through rules 104. A weight or importance of each design principle 102 can differ per user. Example design principles 102 can include user fit, agility, performance, resilience, interoperability, manageability, security, and/or cost optimization.

Example design attributes 110 for organization fit can include user value, user sponsorship, business case, procurement, operation models, adoption/organizational change management, technical readiness, role readiness, and/or governance. User value can correspond to measurable metrics, e.g., cost impact, to track the value the cloud-based platform is providing to the user. User sponsorship can correspond to confirmed support from users for the cloud initiative, such as a confirmed charter. Business case can correspond to performing a cost-benefit analysis and confirming a return on investment. Procurement can correspond to proper channels being established to procure cloud resources. Operation model can correspond to operation models being in place to support cloud services and infrastructure. Adoption/organizational change management (ACM/OCM) can correspond to ACM/OCM being in place to support a transition to the cloud-based platform. Technical readiness can correspond to a technical ability to execute the cloud-based platform, such as through training users. Role readiness can correspond to ensuring users are aligned with existing or new roles to support the cloud-based platform. Governance can correspond to using cloud aware governance models to manage the cloud-based platform, including one or more sets of rules and/or policies.

Example design attributes 110 for agility can include globalization, localization, flexibility, extensibility, replaceability, upgradeability, and/or intelligence. Globalization can correspond to features and characteristics of the service for the cloud-based platform being language, culture, and market neutral. Localization can correspond development of applications and content for the service that can be efficiently localized with changes to code. Flexibility can correspond to support of customization of the service. Extensibility can correspond to considering future growth and additional capabilities. Replaceability can correspond to an ability to switch out applications or replace components of the service more easily, which can be common in microservice architectures. Upgradeability can correspond to ease and isolation of an upgrade from one version of the service to the next, which can be common in microservice architectures. Intelligence can correspond to whether the service can include self-tuning and/or machine learning capabilities that enhance the service over time.

Example design attributes 110 for performance can include scalability, data gravity, and/or speed. Scalability can correspond to supporting growing amounts of load via service expansion. Data gravity can correspond to considering location of data in the design as it relates to performance and scale. Speed can correspond to an ability of the service to process transactions within requisite timeframes.

Example design attributes 110 for resilience can include high availability, graceful degradation, disaster recovery, and/or resiliency. High availability can correspond to supporting uptime for a component level redundance within a given site. For example, a configuration that enabled failover between multiple nodes can be preferable to one that was not or could not be made highly available. Graceful degradation can correspond to allowing continuation of operations in event of a scheduled maintenance or failure of some components that ensure quality decreases proportionally to severity. Disaster recovery can correspond to providing service continuity should any component fail, such as enabling failover to another region. Resiliency can correspond to an ability to recover quickly from failure.

Example design attributes 110 for interoperability can include portability, data centric/agnostic, application compatibility, supportability, hybrid/multi-cloud support, embrace open source, federation and single sign-on (SSO), external software as a service (SaaS) integration, and/or ecosystem. Portability can correspond to the service supporting a future migration to another cloud-based platform. Data centric/agnostic can correspond to data sources allowing for applications to be replaced or multiple applications to be integrated into the service. Application compatibility can correspond to an ability of software to run within stated environments and configurations, such as including cross platform support. Supportability can correspond to following best practices and guidelines published by the cloud-based platform operator. Hybrid/multi-cloud support can correspond to an ability to connect legacy applications across clouds. Embrace open source can correspond to avoiding lock-in with open source platforms and management tools. Federation and SSO can correspond to an ability to authenticate to third party services using one set of credentials. External SaaS integration can correspond to data movement between an external third party and internal systems. Ecosystem can correspond to configurations or optimizations to allow software and/or services from the same vendor or part of a larger solution to work more optimally together.

Example design attributes 110 for manageability can include operational excellence, monitoring, reporting, traceability, authentication, protection, onboard/offboard ease, continuous improvement, automation, and/or no ops. Operational excellence can correspond to an amount of servers or number of devices as well as adding more system/components to management, such as software development and information technology integration. Monitoring can correspond to an ability to control and observe the system. Reporting can correspond to automatically or manually generating system health and monitoring reports. Traceability can correspond to an ability to define, capture, and/or follow traces left by requirements on other elements of the system. Authentication can correspond to components supporting required authentication methods. Protection can correspond to reducing attack surfaces, such as through encryption, least privileges, etc. Onboard/offboard ease can correspond to an ability to add, remove, and/or replace a service within a specific service level agreement. Continuous improvement can correspond to designing the system with a feedback loop to ensure improvements can be made over time. Automation can correspond to implementing continuous integration/continuous deployment (CI/CD) pipelines and infrastructure as code. No ops can correspond to ease of use, automatic scaling, and implementing click to deploy capabilities.

Example design attributes 110 for security can correspond to compliance, auditing/logging/reporting, threat management, multi-tenant, secure by default, data protection, and/or physical access. Compliance can correspond to adherence to security standards, regulations, and/or protocols. Auditing/logging/reporting can correspond to an ability to perform a systematic check for assessment, with traceability and reports. Threat management can correspond to an ability to manage security risks. Multi-tenant can correspond to an ability to support multiple tenants within a single service. Secure by default can correspond to ensuring encryption of data at rest across all platforms by default. Data protection can correspond to redacting sensitive data with predefined and custom detectors. Physical access can correspond to network and data centers being directly managed by the operator of the cloud-based platform.

Example design attributes 110 for cost optimization can correspond to automatic savings, commitment based savings, rightsizing, consumption first, and/or bootstrap your own latent (BYOL). Automatic savings can correspond to sustained use discounts being automatically applied. Commitment based savings can correspond to savings realized through longer term commitments to the cloud-based platform. Rightsizing can correspond to leveraging appropriately sized resources based on utilization, e.g., machine stock keeping units, or workload requirements, e.g., preemptible virtual machines. Consumption first can correspond to taking advantage of consumption per transaction based services over runtime based services. BYOL can correspond to leveraging BYOL to reduce licensing costs.

A module 112 can correspond to a collection of rules 104. Modules 112 can be defined at the cloud service level and can define a set of standards 106 and recommendations for the service.

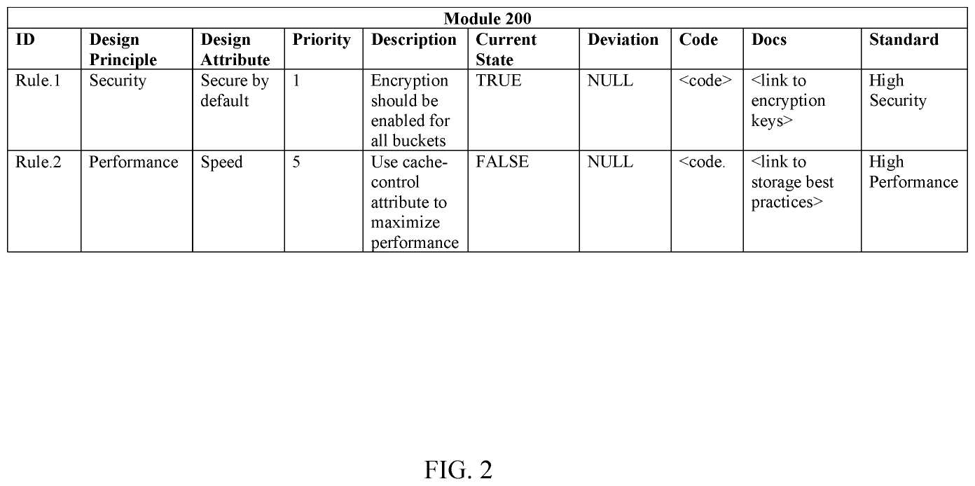

A rule 104 can correspond to a specific guidance or recommendation, which can be represented in a binary statement, e.g. true/false, for a specific configuration made on a single module 112. Each rule 104 can include one or more of the following elements as data 116: an identifier, a design principle 102 and design attribute 110 pair, a priority which can be used to weigh the importance of alignment with the rule 104, a description which can correspond to a human readable description to what is measured, code which can correspond to source code to detect alignment as binary, e.g., true/false, documentation which can correspond to a link to support the rule 104, and a standard 106 which can correspond to one or more predefined standards with which the rule 104 should align. Each rule 104 can have a dynamic state that can be determined during an evaluation of a template 108. A current state can correspond to detection of alignment with a rule 104 and a deviation can correspond to a user supplied reason for ignoring a rule 104. FIG. 2 depicts an example module 200 corresponding to a set of rules.

A template 108 can correspond to a collection of specific configurations of modules 112 based on a desired state for the rules 104 on those services. The template 108 can correspond to a specific configuration of which rules 104 of modules 112 should be considered required or disabled. A specific rule 104 defined on a module 112 can represent a recommendation for a scenario from the operator of the cloud-based platform. Since the rule 104 on its own cannot define the scope of a scenario, templates 108 provide a holistic collection and view of multiple modules 112 and the underlying rules 104.

The templates 108 can represent different types of architectures that can be generated, such as theoretical, directional, and/or prescriptive based architectures. Theoretical based architectures can account for design principles, architecture patterns, architecture workshops, and/or architectural alignment and guidance. Directional based architectures can account for design elements, architecture standards, architectural alignment and guidance, deployment guidance, recommended practices, product guidance, and/or design workshop. Prescriptive based architectures can account for templates, use cases, and solutions, snapshots, real-world experiences, measured alignment, product limitations, support requirements, deployment guidance, recommended practices, product guidance, and/or design workshop. In general, elements can be represented specifically by collections of rules 104 that form patterns 108. For example, product limitations can be captured by a rule such that a maximum supported load is captured as a condition in a rule. Similarly, recommended practice for deploying specific components in a scenario can be captured as conditions on when to include certain design elements or not.

Templates 108 represent a desired configuration of a user as well as the point of view of the operator at a solution level. Templates 108 can be implemented to support management and validation of alignment to the template 108 as well as infrastructure as code for deployment of the configurations, such as a blueprint solution to enable the creation of blueprints that can support both auditing and deployment of architectures that align with the architecture as a service system 100. Tags 114 of the template 108 allow for matching on tagged modules 112 to apply a specific template 108. Since the tag 114 is meant to identify the template 108, there can be a one-to-one relationship between tags 114 and templates 108. A tag 114 can be found on many services running on the cloud-based platform. A service can also have multiple tags 114 to be analyzed against multiple templates 108.

Tags 114 on templates 108 can be how a deployed environment for a service is measured against the architecture as a service framework. As a result, tags 114 can mark applications and solutions that the user has chosen to deploy. When multiple applications of the same type are deployed, tags 114 can be used to identify specific instances of an application by including an identifier appended to the tag 114. For example, each component of an N-Tier web application can be assigned a unique tag 114 in order to associate it with a desired template 108. Assigning a unique tag 114 allows each web application to be scanned independently against the template rule sets, which may check for architecture elements such as front end and database deployed in the same region or for SSL enforcement at the front end. Tags 114 can define and identify applications and solutions deployed on the cloud-based platform.

Standards 106 can be more rigid and specific in achieving a goal, such that standards cannot be altered. Either a standard 106 is met or not. Standards 106 can correspond to properties of rules 104 from a predefined list. Standards 106 can include security standards or alignment with other certifications. A standard 106 can be used to indicate alignment with any priority that is not a design principle 102 but should be tracked or measured, such as high performance, since those configurations may be optional generally. Since standards 106 can be applied at the rule level and rule alignment can be measured through binary output, alignment with a standard 106 can be quickly measured. Required configurations to meet a standard 106 can also be identified through the binary output.

Reasons for deviation from a template 108 can be defined to support measurable and consistent reporting of alignment with rules 104. Example reasons for deviation can include user preference, complexity, resourcing, and/or cost prohibition. User preference can correspond to a general catch all that could include anything from technology bias to internal standards or strategic preference. Complexity can correspond to a user unwilling to align due to a feeling the design element is overly complicated to what they are able to manage. Resourcing can correspond to a lack of ability to manage or maintain the configuration element. Cost prohibition can correspond to introduction of a change may be more than a user can take on.

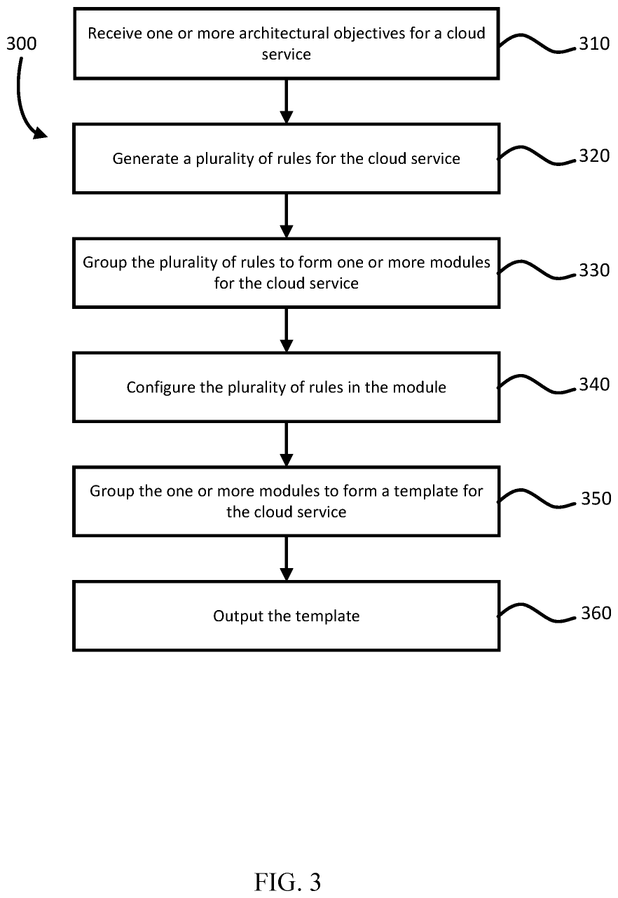

FIG. 3 depicts a flow diagram of an example process 300 for generating templates 108 for an architecture as a service framework. The example process 300 can be performed on a system of one or more processors in one or more locations, such as the architecture as a service system 100 of FIG. 1.

As shown in block 310, the system 100 can receive one or more architectural objectives 120 for a cloud service. The architectural objectives 120 can include one or more design principles 102, system requirements 124, conditions 122, and/or standards 106. The design principles 102 can each include one or more design attributes 110.

As shown in block 320, the system 100 can generate a plurality of rules 104 for the cloud service based on the architectural objectives 120. For example, individual rules can be associated with particular design principles 102, system requirements 124, conditions 122, and/or standards 106 of the architectural objectives 120. The individual rules for each design principle, system requirement, condition, and/or standard of the architectural objectives 120 can be consolidated to form the plurality of rules 104. Individual rules being associated with particular design principles, system requirements, conditions, and/or standards can be static or dynamic.

As shown in block 330, the system 100 can group the plurality of rules 104 to form one or more modules 112 for the cloud service based on one or more conditions of the architectural objectives. The conditions 122 can be within a rule or between rules of the plurality of rules. For example, a condition can correspond to using a load balancer when there are two or more servers in an array. This condition was between rules as it checks for server count but is about a load balancer. An example condition within a rule can correspond to ensuring a cache is on when a disk array is detected.

As shown in block 340, the system 100 can also configure individual rules 104 of the plurality of rules in the module 112 based on the conditions 122. For example, the system 100 can determine which individual rules 104 of the plurality of rules in the module 112 can be enabled or disabled based on the conditions 122.

As shown in block 350, the system 100 can group the one or more modules 112 to form a template 108 for the cloud service based on tagging of the rules in each module 112.

As shown in block 360, the system 100 can output the template 108. The template 108 can be reviewed to determine an alignment with the architectural objectives 120.

The framework for the architecture as a service system 100 can include a rule editor interface. The rule editor can include a filter configured to filter by module 112, design principle 102, and/or standard 106. The rule editor can further include an ability to view all rules 104 for a module 112. The rule editor can also include an ability to create, read, update, and/or delete individual rules 104, modules 112, standards 106, and/or reasons for deviation. The rules 104, modules 112, standards 106 and/or reasons for deviation can be created in a draft mode before being released/published.

The framework for the architecture as a service system 100 can further include a user interface for a user to interface with rules sets to enable/disable rules 104, initiate and review resultant templates from architectural objectives, and/or review available rules 104 and templates 108. The user interface can allow a user to review templates 108 and associated tags 114 to apply to cloud services. The user interface can also allow a user to enable/disable modules 112. For a template 108 that depends on a module 112, the user interface can warn the user that template finding can be incomplete due to the disabled module 112. The user interface can further include a module review, which allows a user to walk through the set of rules 104 that define preferences and document deviations as reasons for turning off any rules 104.

The user interface can allow a user to create a new scan, including attributes such as a custom label. The user can choose between a baseline scan, without templates 108, or a template scan using tags 114. The user can then review the completed scan with a report showing alignment, reasons for deviation, etc. The user interface can include an overall alignment dashboard with summaries and reports of recent scans. The user interface can indicate to a user that a completed scan should be refreshed due to new rules 104 available in a module 112. The user interface can also indicate to a user when a new module 112 or solution is available to analyze.

The architecture as a service system 100 can be maintained in a database of a cloud-based platform with a front end user interface. Migration and assessment tools can be included for automation of tagging. For example, assessment tools can identify at a workload level what is running inside a virtual machine in order to recommend tags 114 that should be applied to map a solution or technology. The assessment tools can also identify application dependencies to ensure related and dependent services are tagged together for a single application. Once workloads and application dependencies are identified, migration tools can be used to apply the tags 114 recommended as part of a resource migration process.

Calculating relative weight or importance of a rule can be complicated, especially if hard coding these weights. Instead, one or more machine learning models can be used to calculate the relative weight of rules using a training approach. The machine learning model can also be used to generate one or more rules. Each rule can be evaluated for its relative weight within its own design principle. For example, it can be known how important a rule for performance is for achieving performance. Rules can also be scored for central or broader goals and/or other design principles, such as understanding impact a design element has on cost. Cost is typically harder to use as a design principle since a system designed solely for cost would be a system with little to no functionality. Using a machine learning model can provide a more elegant way to handle goals like cost by allowing an understanding of cost impact on each design element. Should a desire to lower the cost of the solution be required, then the immediate impact to reducing cost would be known by the calculated weight of the rules, design principles, standard, etc. being removed. This would allow for removing an element for higher performance rather than one that compromises security, for example. A sandbox or live environment can be implemented in some cases, such as to validate performance, while access to external data such as a list of SKUs with cost can be sufficient in other cases.

Sources of knowledge for an architecture can be static or dynamic. Static can correspond to a specific pattern or design element while dynamic can correspond to a generated design or configuration element or set of generated elements. Architecture as a service can generate dynamic architectures collectively. For instance, the output of the system can be knowledge with the input of architectural objectives and leveraging an initial set of static and/or dynamic knowledge from one or more sources. Using machine learning models, knowledge can be generated dynamically. The machine learning models can learn that, under certain conditions, a specific set of configurations can achieve an optimal performance that differs from the initial set of configurations. The specific set of configurations can include inclusion of an additional component or removal of a point of failure. The machine learning models can suggest elements to include when constructing an initial state architecture based on known patterns.

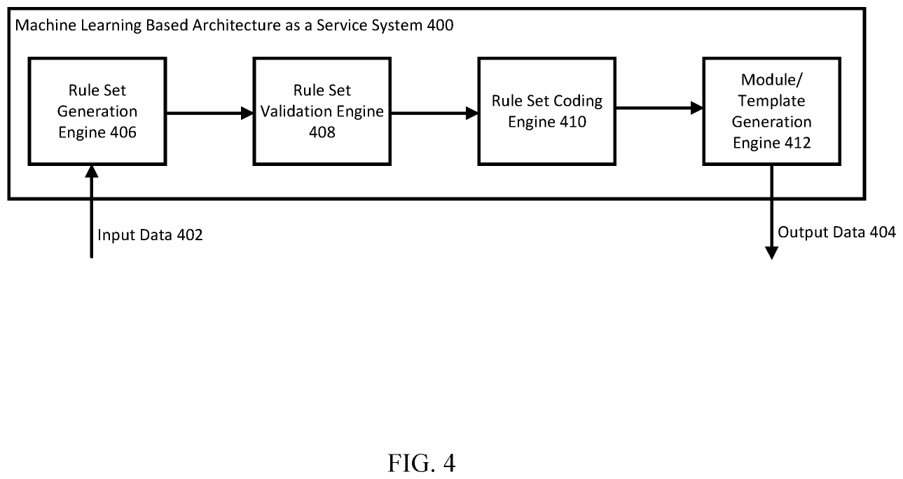

FIG. 4 depicts a block diagram of a machine learning based architecture as a service system 400 for a cloud-based platform. The machine learning based architecture as a service system 400 can be part of or in addition to the architecture as a service system 100 as depicted in FIG. 1. The machine learning based architecture as a service system 400 can be implemented on one or more computing devices in one or more locations.

The machine learning based architecture as a service system 400 can be configured to receive input data 202. For example, the machine learning based architecture as a service system 400 can receive the input data 402 as part of a call to an application programming interface (API) exposing the machine learning based architecture as a service system 400 to one or more computing devices. The input data 402 can also be provided to the machine learning based architecture as a service system 400 through a storage medium, such as remote storage connected to the one or more computing devices over a network. The input data 402 can further be provided as input through a user interface on a client computing device coupled to the machine learning based architecture as a service system 400.

The input data 402 can include instructions to generate rule sets conforming to one or more standards and/or align with one or more design principles and design attributes. The prompts can further include instructions for validating rules sets that are generated as well as processing the rule sets into modules and/or templates. The instructions can be implemented as prompts or queries to be received by the machine learning based architecture as a service system 400.

From the input data 402, the machine learning based architecture as a service system 400 can be configured to output one or more results generated as output data 404. For example, the machine learning based architecture as a service system 400 can be configured to send the output data 404 for display on a client or user display. As another example, the machine learning based architecture as a service system 400 can be configured to provide the output data 404 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The machine learning based architecture as a service system 400 can further be configured to forward the output data 404 to one or more other devices configured for translating the output data into an executable program written in a computer programming language. The machine learning based architecture as a service system 400 can also be configured to send the output data 404 to a storage device for storage and later retrieval.

The output data 404 can include one or more rule sets implemented as a structured data set. The output data 404 can further include one or more modules and/or templates for implementing an architecture in the cloud-based platform. The rule sets, modules, and/or template can be responses to the prompts or queries.

The machine learning based architecture as a service system 400 can include a rule set generation engine 406, a rule set validation engine 408, a rule set coding engine 410, and a module and/or template generation engine 412. The rule set generation engine 406, rule set validation engine 408, rule set coding engine 410, and module and/or template generation engine 412 can be implemented as one or more computer programs, specially configured electronic circuitry, or any combination thereof.

The rule set generation engine 406 can be configured to generate one or more rule sets using one or more machine learning models. The machine learning models can be generative models, such as large generative models like large language models. The machine learning models can be general usage models or models fine-tuned to the task of generating architectures for cloud-based platforms. The rule set generation engine 406 can generate the rule sets to align with one or more standards, design principles, and/or design attributes. The rule set generation engine 406 can be configured to generate rules in the rule sets that are binary, measurable, and precise.

Binary may refer to the rule having an expected or known outcome to eliminate ambiguity in measuring the rule. For example, binary may refer to the rule being a yes/no or true/false statement for whether the architecture aligns with the rule. Measurable may refer to being able to evaluate the rule without ambiguity on whether the architecture aligns with the rule. For example, “secure the data” is an unmeasurable rule but “all data should be encrypted with AES256 encryption” is a measurable rule. As another example, “set the caching to enable faster processing” when there are multiple possible settings for the cache is unmeasurable but “set the caching to high to enable faster processing” is a measurable rule. Binary can often imply that the rule is measurable as well. Precise may refer to ensuring the rule has clear context and conditions for which a rule may apply. For example, “turn on storage caching for high performance systems” is not precise enough but “if performance of 1000 IOPs or greater is required, turn on storage caching” is precise. Precise may ensure that terms in the rules have clear definitions, such as not being relative.

The rule set validation engine 408 can be configured to determine whether the generated rules in the rule set meet a quality threshold. For example, the rule set validation engine 408 can determine whether any of the rules constitute hallucinations or are otherwise out of place for the architecture in which they can be implemented. The rule set validation engine 408 can use one or more machine learning models to determine whether the generated rules meet the quality threshold. The one or more machine learning models can be the same models that generated the rules or additional models specifically configured to validate generated rules for architectures in cloud-based platforms. In response to determining one or more of the rules do not meet the quality threshold, the rule set validation engine 408 can correct those rules. In response to determining the rule set meets the quality threshold, the rule set validation engine 408 can authorize the rule set for utilization in an architecture.

The rule set coding engine 410 can be configured to convert the rule set into one or more code snippets representative of the rule set. The rule set coding engine 410 can use one or more machine learning models to convert the rule set into the code snippets. The one or more machine learning models can be the same models that generated the rules or additional models specifically configured to generate code snippets from natural language. For example, the code snippet can be for detection of one or more conditions to initiate the rule set or to set a state for the architecture as described in the rule set. Generating code snippets, rather than natural language, allows the rule sets to be easily implemented within existing architectures in the cloud-based platform as well as new architectures for the cloud-based platform. The rule set coding engine 410 can be implemented as part of the rule set generation engine 406 or as a separate engine. If part of the rule set generation engine 406, the rule set generation engine 406 can generate rule sets as code snippets, which can then be reviewed by the rule set validation engine 408.

The rule set coding engine 410 can further store the code snippets as structured data, such as in a JSON format, that defines each rule with attributes for the design principle, design attributes, dependencies, standards, etc., as defined in the schema for rules as well as the associated code snippets for detection and/or configuration of that rule in an architecture. The structured data format can allow the one or more machine learning models to more easily and accurately respond to requests for architecture recommendations. The structured data format can also make the machine learning models less prone to hallucinations, as the rule sets stored in the structured data format were already reviewed by the rule set validation engine 408.

The module and/or template generation engine 412 can be configured to generate modules from the rule sets and/or templates from the modules using one or more machine learning models. The one or more machine learning models can be the same machine learning models that generated the rule set or additional models specifically configured to group rule sets into modules and/or group modules into templates. The module and/or template generation engine 412 can group rule sets into modules based on conditions and/or objectives for implementing an architecture of a cloud-based platform. The module and/or template generation engine 412 can group modules into templates based on how the modules and/or rule sets are tagged. The modules and/or templates can be utilized to more easily update an existing architecture or implement a new architecture in a cloud-based platform according to recommendations, goals, or objectives for the architecture.

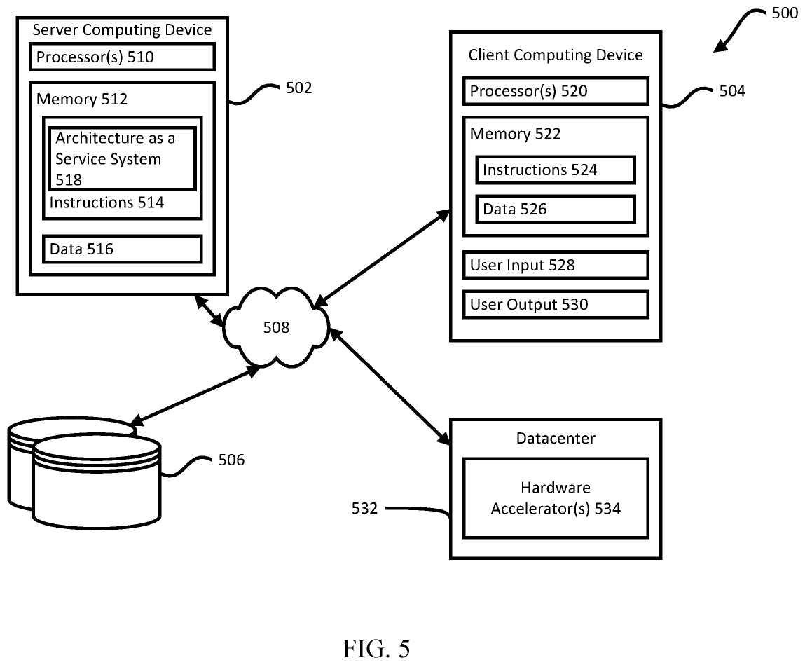

FIG. 5 depicts a block diagram of an example environment 500 for implementing an architecture as a service system 518. The architecture as a service system 518 can be implemented on one or more devices having one or more processors in one or more locations, such as in server computing device 502. A client computing device 504 and the server computing device 502 can be communicatively coupled to one or more storage devices 506 over a network 508. The storage devices 506 can be a combination of volatile and non-volatile memory and can be at the same or different physical locations than the computing devices 502, 504. For example, the storage devices 506 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 502 can include one or more processors 510 and memory 512. The memory 512 can store information accessible by the processors 510, including instructions 514 that can be executed by the processors 510. The memory 512 can also include data 516 that can be retrieved, manipulated, or stored by the processors 510. The memory 512 can be a type of transitory or non-transitory computer readable medium capable of storing information accessible by the processors 510, such as volatile and non-volatile memory. The processors 510 can include one or more central processing units (CPUs), graphics processing units (GPUs), field-programmable gate arrays (FPGAs), and/or application-specific integrated circuits (ASICs), such as tensor processing units (TPUs) and/or wafer scale engines (WSEs).

The instructions 514 can include one or more instructions that, when executed by the processors 510, cause the one or more processors 510 to perform actions defined by the instructions 514. The instructions 514 can be stored in object code format for direct processing by the processors 510, or in other formats including interpretable scripts or collections of independent source code modules that are interpreted on demand or compiled in advance. The instructions 514 can include instructions for implementing the architecture as a service system 518. The architecture as a service system 518 can correspond to the architecture as a service system 100 as depicted in FIG. 1, the machine learning based architecture as a service system 400 as depicted in FIG. 4, or any combination thereof. The architecture as a service system 518 can be executed using the processors 510, and/or using other processors remotely located from the server computing device 502.

The data 516 can be retrieved, stored, or modified by the processors 510 in accordance with the instructions 514. The data 16 can be stored in computer registers, in a relational or non-relational database as a table having a plurality of different fields and records, or as JSON, YAML, proto, or XML documents. The data 516 can also be formatted in a computer-readable format such as, but not limited to, binary values, ASCII, or Unicode. Moreover, the data 516 can include information sufficient to identify relevant information, such as numbers, descriptive text, proprietary codes, pointers, references to data stored in other memories, including other network locations, or information that is used by a function to calculate relevant data.

The client computing device 504 can also be configured similarly to the server computing device 502, with one or more processors 520, memory 522, instructions 524, and data 526. The client computing device 504 can also include a user input 528 and a user output 530. The user input 528 can include any appropriate mechanism or technique for receiving input from a user, such as keyboard, mouse, mechanical actuators, soft actuators, touchscreens, microphones, and sensors.

The server computing device 502 can be configured to transmit data to the client computing device 504, and the client computing device 504 can be configured to display at least a portion of the received data on a display implemented as part of the user output 530. The user output 530 can also be used for displaying an interface between the client computing device 504 and the server computing device 502. The user output 530 can alternatively or additionally include one or more speakers, transducers or other audio outputs, a haptic interface or other tactile feedback that provides non-visual and non-audible information to the platform user of the client computing device 504.

Although FIG. 5 illustrates the processors 510, 520 and the memories 512, 522 as being within the respective computing devices 502, 504, components described herein can include multiple processors and memories that can operate in different physical locations and not within the same computing device. For example, some of the instructions 514, 524 and the data 516, 526 can be stored on a removable SD card and others within a read-only computer chip. Some or all of the instructions 514, 524 and data 516, 526 can be stored in a location physically remote from, yet still accessible by, the processors 510, 520. Similarly, the processors 510, 520 can include a collection of processors that can perform concurrent and/or sequential operation. The computing devices 502, 504 can each include one or more internal clocks providing timing information, which can be used for time measurement for operations and programs run by the computing devices 502, 504.

The server computing device 502 can be connected over the network 508 to a data center 532 housing any number of hardware accelerators 534. The data center 532 can be one of multiple data centers or other facilities in which various types of computing devices, such as hardware accelerators, are located. Computing resources housed in the data center 532 can be specified for deploying one or more machine learning models as described herein.

The server computing device 502 can be configured to receive requests to process data from the client computing device 504 on computing resources in the data center 532. For example, the environment 500 can be part of a computing platform configured to provide a variety of services to users, through various user interfaces and/or application programming interfaces (APIs) exposing the platform services. As an example, the variety of services can include generating rule sets, modules, and/or templates for updating existing architecture or creating new architectures for a cloud-based platform. The client computing device 504 can transmit input data as part of a query to generate an architecture. The architecture as a service system 518 can receive the input data, and in response, generate output data including a response to the query for generating the architecture.

The server computing device 502 can maintain a variety of machine learning models in accordance with different constraints available at the data center 532. For example, the server computing device 502 can maintain different families for deploying machine learning models on various types of TPUs and/or GPUs housed in the data center 532 or otherwise available for processing.

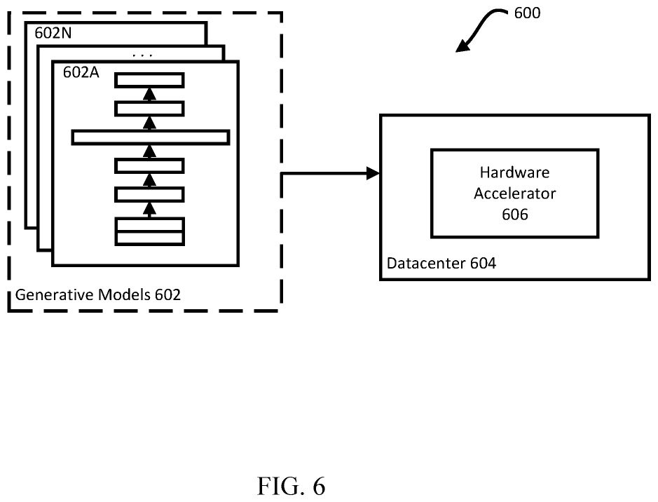

FIG. 6 depicts a block diagram 600 illustrating one or more machine learning model architectures 602, more specifically 602A-N for each architecture, for deployment in a datacenter 604 housing a hardware accelerator 606 on which the deployed machine learning models 602 will execute, such as for the variety of services as described herein. The hardware accelerator 606 can be any type of processor, such as a CPU, GPU, FPGA, or ASIC such as a TPU or WSE.

An architecture 602 of a machine learning model can refer to characteristics defining the model, such as characteristics of layers for the model, how the layers process input, or how the layers interact with one another. The architecture 602 of the machine learning model can also define types of operations performed within each layer. One or more machine learning model architectures 602 can be generated that can output results, such as for generating rule sets, modules, and/or templates for architectures of a cloud-based platform. Example model architectures 602 can correspond to large generative models, such as large language models.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

The machine learning models can be trained on various training data associated with generating architectures for a cloud-based platform. The training data can include text, graphics, tables, audio, and/or video associated with architecture documentation. For example, text can be written descriptions of architectures, graphics can be written diagrams of architectures, tables can be inventory or component lists for architectures, audio and/or video can be recorded descriptions of architectures.

Training the machine learning models can include pre-training a foundation multimodal model followed by supervised or unsupervised fine-tuning on the various training data associated with generating architectures, pre-training a foundation multimodal model where the pre-training includes the various training data associated with generating architectures, and/or pre-training various single modal models followed by supervised or unsupervised fine-tuning of each model on one or more of the various training data associated with generating architectures. Training the machine learning models can further include tuning and customization to further fine-tune the models, such as via reinforcement learning with human feedback, reinforcement learning with AI feedback, instruction tuning or similar techniques to enhance execution of the specific tasks for generating architectures for a cloud-based platform, and/or model orchestration techniques, such as mixture of experts, to enable multiple specialized models for generating the architectures for the cloud-based platform.

Referring back to FIG. 5, the devices 502, 504 and the data center 532 can be capable of direct and indirect communication over the network 508. For example, using a network socket, the client computing device 504 can connect to a service operating in the data center 532 through an Internet protocol. The devices 502, 504 can set up listening sockets that may accept an initiating connection for sending and receiving information. The network 508 can include various configurations and protocols including the Internet, World Wide Web, intranets, virtual private networks, wide area networks, local networks, and private networks using communication protocols proprietary to one or more companies. The network 508 can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 508, in addition or alternatively, can also support wired connections between the devices 502, 504 and the data center 532, including over various types of Ethernet connection.

Although a single server computing device 502, client computing device 3504, and data center 532 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for continuous architecture as a service comprising:
receiving, by one or more processors, data associated with one or more architectural objectives for a cloud service;
generating, by the one or more processors, a plurality of rules for the cloud service based on the data associated with the one or more architectural objectives;
grouping, by the one or more processors, the plurality of rules to form one or more modules for the cloud service based on one or more conditions of the architectural objectives;
configuring, by the one or more processors, the plurality of rules in the one or more modules based on the one or more conditions;
grouping, by the one or more processors, the one or more modules to form a template architecture for the cloud service based on tagging of rules within the one or more modules; and
outputting, by the one or more processors, the template architecture for the cloud service.

2. The method of claim 1, wherein the data associated with the one or more architectural objectives further comprises data associated with one or more design principles.

3. The method of claim 1, wherein the data associated with the one or more architectural objectives further comprises data associated with one or more system requirements or standards.

4. The method of claim 1, further comprising determining, by the one or more processors, the plurality of rules in the template architecture aligns with the cloud service.

5. The method of claim 4, further comprising:
tagging, by the one or more processors, the template architecture with a unique identifier; and
deploying, by the one or more processors, the template architecture in response to determining the template architecture aligns with the cloud service.

6. The method of claim 1, further comprising determining, by the one or more processors, at least one of the plurality of rules in the template architecture does not align with the cloud service.

7. The method of claim 6, further comprising:
deviating, by the one or more processors, from the template architecture to generate a deviated template architecture that alters at least one of the plurality of rules in response to determining the template architecture does not align with the cloud service;
tagging, by the one or more processors, the deviated template architecture with a unique identifier; and
deploying, by the one or more processors, the deviated template architecture.

8. The method of claim 7, further comprising generating, by the one or more processors, one or more reasons for deviating from the template architecture.

9. The method of claim 1, wherein at least one of the generation of the plurality of rules, grouping of the plurality of rules, configuring of the plurality of rules, or grouping of the one or more modules is performed by one or more machine learning models.

10. The method of claim 9, further comprising:
converting, by the one or more processors, the plurality of rules into code snippets; and
storing, by the one or more processors, the code snippets as structured data.

11. The method of claim 1, wherein:
each rule of the plurality of rules comprises a binary statement; and
configuring each rule further comprises enabling or disabling each rule.

12. A system comprising:
one or more processors; and
one or more storage devices coupled to the one or more processors and storing instructions that, when executed by the one or more processors, cause the one or more processors to perform operations for a continuous architecture as a service, the operations comprising:
receiving data associated with one or more architectural objectives for a cloud service;
generating a plurality of rules for the cloud service based on the data associated with the one or more architectural objectives;
grouping the plurality of rules to form one or more modules for the cloud service based on one or more conditions of the architectural objectives;
configuring the plurality of rules in the one or more modules based on the one or more conditions;
grouping the one or more modules to form a template architecture for the cloud service based on tagging of rules within the one or more modules; and
outputting the template architecture for the cloud service.

13. The system of claim 12, wherein the operations further comprise determining the plurality of rules in the template architecture aligns with the cloud service.

14. The system of claim 13, wherein the operations further comprise:
tagging the template architecture with a unique identifier; and
deploying the template architecture in response to determining the template architecture aligns with the cloud service.

15. The system of claim 12, wherein the operations further comprise determining at least one of the plurality of rules in the template architecture does not align with the cloud service.

16. The system of claim 15, wherein the operations further comprise:
deviating from the template architecture to generate a deviated template architecture that alters at least one of the plurality of rules in response to determining the template architecture does not align with the cloud service;
tagging the deviated template architecture with a unique identifier; and
deploying the deviated template architecture.

17. The system of claim 16, wherein the operations further comprise generating one or more reasons for deviating from the template architecture.

18. The system of claim 12, wherein at least one of the generation of the plurality of rules, grouping of the plurality of rules, configuring of the plurality of rules, or grouping of the one or more modules is performed by one or more machine learning models.

19. The system of claim 18, wherein the operations further comprise:
converting the plurality of rules into code snippets; and
storing the code snippets as structured data.

20. A non-transitory computer readable medium for storing instructions that, when executed by one or more processors, cause the one or more processors to perform operations for a continuous architecture as a service, the operations comprising:
receiving data associated with one or more architectural objectives for a cloud service;
generating a plurality of rules for the cloud service based on the data associated with the one or more architectural objectives;
grouping the plurality of rules to form one or more modules for the cloud service based on one or more conditions of the architectural objectives;
configuring the plurality of rules in the one or more modules based on the one or more conditions;
grouping the one or more modules to form a template architecture for the cloud service based on tagging of rules within the one or more modules; and
outputting the template architecture for the cloud service.
